(19) United States
(12) Patent Application Publication
(10) Pub. No.: US 2020/0142867 A1
(43) Pub. Date: May 7, 2020

(54) INTELLIGENT PUSHING METHOD AND SYSTEM FOR RELATED CONTENTS OF NEWLY-CREATED ENTRIES

(71) Applicant: SHANGHAI YIWEI NETWORK TECHNOLOGY CO., LTD., Shanghai (CN)

(72) Inventor: Zhengfang MA, Shanghai (CN)

(21) Appl. No.: 16/739,050

(22) Filed: Jan. 9, 2020

Related U.S. Application Data
(63) Continuation of application No. PCT/CN2018/096947, filed on Jul. 25, 2018.

(30) Foreign Application Priority Data
Jul. 26, 2017 (CN) 201710617448.1

(51) Int. Cl. G06F 16/18; G06F 16/182; G06F 16/901

(52) U.S. Cl. CPC G06F 16/1873; G06F 16/9027; G06F 16/1827

(57) ABSTRACT

The present invention discloses an intelligent pushing method and system for related contents of newly-created entries, which can enhance the efficiency and convenience of creating a new entry structure on an entry structured platform and improve the experience of users. The technical solutions are as follows: an original or synthetic entry structure related to a new entry searched on a platform is provided to a creator of the new entry, and the selected entry structure is inserted in a structure of the new entry and then edited to obtain an entry structure belonging to the creator.

### CROSS-REFERENCE TO RELATED APPLICATIONS

This application is a continuation of International Patent Application No. PCT/CN2018/096947, filed on Jul. 25, 2018, which claims the benefit of priority from Chinese Patent Application No. 201710617448.1, filed on Jul. 26, 2017. The contents of the aforementioned application, including any intervening amendments thereto, are incorporated herein by reference in its entirety.

### TECHNICAL FIELD

The present invention relates to optimization of entry structures, and in particular to a method and system for helping users to quickly construct their own knowledge structures.

### BACKGROUND OF THE PRESENT INVENTION

There are many root entries in a tree-like entry structures, and there are multiple layers of sub-entries subordinate to each root entry. Multiple sub-entries are derived from each sub-entry in each layer to form a complicated entry structure system. There are many users registered on an entry structured platform, and each user is a creator of his/her own entry structure system. When a user creates a new entry on the platform, the user usually needs to start from scratch to gradually construct an entry structure system with great effort by his/her own understanding of the entry related knowledge.

However, in such methods for constructing new entry structures, existing entry structures on the platform cannot be fully utilized, and it is very time-consuming and labor-consuming for users to construct a new entry structure system. Moreover, as one of characteristics of knowledge, sharing cannot be realized during the conventional construction of new entry structures, resulting in degradation of the user experience of the entry structured platform.

### SUMMARY OF THE PRESENT INVENTION

The brief summary of one or more aspects will be given below to provide the basic understanding of these aspects. This summary is not an exhaustive overview of all contemplated aspects, and is not intended to identify key or decisive elements of all aspects or attempt to define the scope of any or all aspects. It is given merely to provide some concepts of one or more aspects in a simplified form, as the foreword of detailed descriptions to be given later.

An objective of the present invention is to provide, to solve the above problems, an intelligent pushing method and system for related contents of newly-created entries, which can enhance the efficiency and convenience of creating a new entry structure on an entry structured platform and improve the experience of users.

The present invention employs the following technical solutions. The present invention discloses an intelligent pushing method for related contents of newly-created entries, including steps of:

transmitting instructions to a cloud server by a terminal device via a communication medium, the cloud server comprising one or more processors and a non-volatile memory storing instructions; during the creation of a new entry in an entry structure, by an original entry search module of the non-volatile memory, searching, based on the new entry to be created and on an entry structured platform, an entry structure of an original entry the same as or similar to the new entry, the entry structured platform storing entry structures created by multiple users; and

recommending, by an entry insertion module of the non-volatile memory and to a creator of the new entry, all searched entry structures for the creator's selection, and inserting the selected entry structure in the created new entry.

In accordance with an embodiment of the intelligent pushing method for related contents of newly-created entries, in the process of inserting the selected entry structure in the created new entry, the selected entry structure is edited by an edition unit, the edition including deletion and addition of the entry structure, and adjustment of a logical relationship among entries.

The method further includes steps of:

during the creation of a new entry in an entry structure, by a synthetic entry recommendation module, searching, based on the new entry to be created and on the entry structured platform, an entry structure of a synthetic entry the same as or similar to the new entry, the entry structured platform storing entry structures created by multiple users and entry structures of the synthetic entries, multiple similar original entry structures being combined into an entry structure of a new synthetic entry; and

inserting, by the entry insertion module, the searched entry structure of the synthetic entry in an entry structure of the new entry.

In accordance with an embodiment of the intelligent pushing method for related contents of newly-created entries, in the process of inserting the searched entry structure of the synthetic entry in the entry structure of the new entry, the entry structure of the synthetic entry is further edited by the edition unit, the edition including deletion and addition of the entry structure, and adjustment of a logical relationship among entries.

In accordance with an embodiment of the intelligent pushing method for related contents of newly-created entries, based on the conversion from the entry structures to texts and a cosine similarity based on the texts, multiple similar original entry structures are automatically combined into an entry structure of a new synthetic entry.

The present invention further discloses an intelligent pushing system for related contents of newly-created entries, including:

a terminal device, the terminal device including an application-specific integrated circuit; and

a cloud server coupled to the terminal device via a communication medium, the cloud server including one or more processors and a non-volatile memory storing instructions, wherein:

the instructions, when executed, cause the one or more processor to receive instructions from the terminal device via the communication medium,

the non-volatile memory of the cloud server includes: an original entry search module configured to, during the creation of a new entry in an entry structure, search, based on the new entry to be created and on an entry structured platform, an entry structure of an original entry the same as or similar to the new entry, the entry structured platform storing entry structures created by multiple users; and

an entry insertion module configured to recommend, to a creator of the new entry, all searched entry structures for the creator's selection and insert the selected entry structure in the created new entry.

In accordance with an embodiment of the intelligent pushing system for related contents of newly-created entries, the entry insertion module includes:

an edition unit configured to edit the selected entry structure, the edition including deletion and addition of the entry structure and adjustment of a logical relationship among entries.

The non-volatile memory of the cloud server further includes:

a synthetic entry recommendation module configured to, during the creation of a new entry in an entry structure, search, based on the new entry to be created and on the entry structured platform, an entry structure of a synthetic entry the same as or similar to the new entry, the entry structured platform storing entry structures created by multiple users and entry structures of the synthetic entries, multiple similar original entry structures being combined into an entry structure of a new synthetic entry; and

the entry insertion module is further configured to insert the searched entry structure of the synthetic entry in an entry structure of the new entry.

In accordance with an embodiment of the intelligent pushing system for related contents of newly-created entries, the edition unit is further configured to edit the synthetic entry structure to be inserted, the edition including deletion and addition of the entry structure and adjustment of a logical relationship among entries.

In accordance with an embodiment of the intelligent pushing system for related contents of newly-created entries, based on the conversion from the entry structures to texts and a cosine similarity based on the texts, multiple similar original entry structures are combined into an entry structure of a new synthetic entry.

Compared with the prior art, the present invention has the following beneficial effects. An original or synthetic entry structure related to a new entry searched on a platform is provided to a creator of the new entry, and the selected entry structure is inserted into a structure of the new entry and then edited to obtain an entry structure belonging to the creator. Compared with the conventional technologies, in the present invention, existing resources on the platform can be utilized to help a user to quickly establish a structure system of the new entry. The operating efficiency of the user on the platform is improved.

### BRIEF DESCRIPTION OF THE DRAWINGS

The above features and advantages of the present invention can be better understood upon reading the detailed description of the embodiments of the present disclosure with reference to the accompanying drawings. Throughout the drawings, the components are not necessarily drawn to scale, and the components having similar related characteristics or features may be indicated by the same or similar reference numerals.

FIG. 1 shows a flowchart of a first embodiment of an intelligent pushing method for related contents of newly-created entries according to the present invention;

FIG. 2 shows a flowchart of a second embodiment of the intelligent pushing method for related contents of newly-created entries according to the present invention;

FIG. 3 shows a principle diagram of a first embodiment of an intelligent pushing system for related contents of newly-created entries according to the present invention;

FIG. 4 shows a principle diagram of a second embodiment of the intelligent pushing system for related contents of newly-created entries according to the present invention;

FIG. 5 shows another principle diagram of the second embodiment of the intelligent pushing system for related contents of newly-created entries according to the present invention; and

FIG. 6 shows a flowchart of a method for text combining based on a cosine similarity.

### DETAILED DESCRIPTION OF THE PRESENT INVENTION

The present invention will be described below in detail by specific embodiments with reference to the accompanying drawings. It is to be noted that the aspects to be described hereinafter by specific embodiments with reference to the accompanying drawings are merely exemplary, and shall not be interpreted as any limitations to the protection scope of the present invention.

### First Embodiment of the Intelligent Pushing Method for Related Contents of Newly-Created Entries

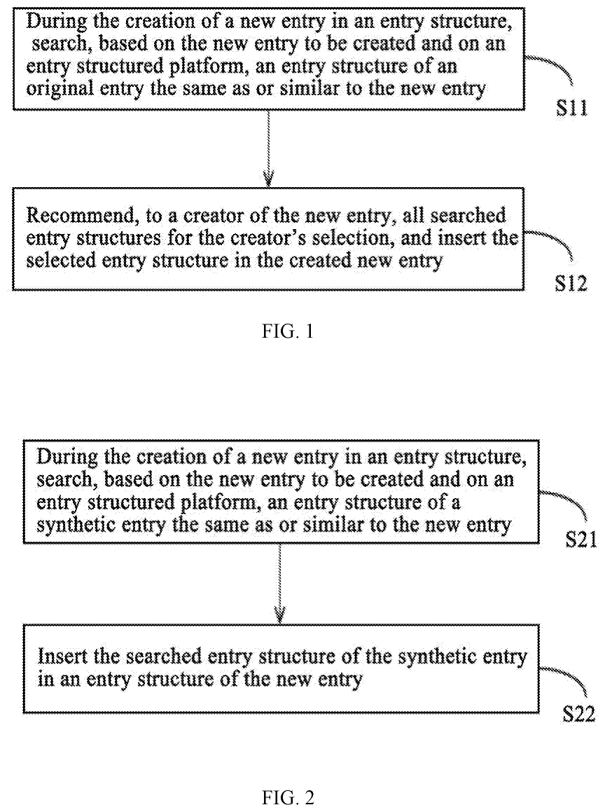

FIG. 1 shows a flowchart of a first embodiment of the intelligent pushing method for related contents of newly-created entries according to the present invention. With reference to FIG. 1, implementation steps of the pushing method in this embodiment will be described below in detail.

A terminal device 200 transmits instructions to a cloud server 100 via a communication medium 300, the cloud server 100 including one or more processors 101 and a non-volatile memory 102 storing instructions. The following steps is executed in the non-volatile memory 102.

S11: During the creation of a new entry in an entry structure, an original entry search module 1021 searches, based on the new entry to be created and on an entry structured platform, an entry structure of an original entry the same as or similar to the new entry.

The entry structured platform stores entry structures created by multiple users. For example, when a creator enters “Physics”, the platform automatically searches, from all the stored entry structures, “Nuclear physics|subordinate to a root entry READING”, “Astrophysics|subordinate to the root entry READING”, “Physics|subordinate to a root entry INTERGENERATION PROFILE”, etc.

S12: An entry insertion module 1022 recommends, to a creator of the new entry, all searched entry structures for the creator's selection and inserts the selected entry structure in the created new entry.

The search result is displayed to the creator of the new entry for the creator's selection and the selected entry structure is then inserted in the new entry. During the insertion process, an edition unit 10221 can further edit the selected entry structure. The edition includes deletion and addition of the entry structure, adjustment of a logical relationship among entries, etc.

### Second Embodiment of the Intelligent Pushing Method for Related Contents of Newly-Created Entries

FIG. 2 shows a flowchart of a second embodiment of the intelligent pushing method for related contents of newly-created entries according to the present invention. With reference to FIG. 2, implementation steps of the pushing method in this embodiment will be described below in detail.

S21: During the creation of a new entry in an entry structure, a synthetic entry recommendation module 1023 searches, based on the new entry to be created and on an entry structured platform, an entry structure of a synthetic entry the same as or similar to the new entry.

The entry structured platform stores entry structures created by multiple users and entry structures of the synthetic entries. Multiple similar original entry structures are combined into an entry structure of a new synthetic entry.

The formation of the synthetic entry depends on the conversion from the entry structures to texts and a cosine similarity based on the texts. More specifically, the original entry structures are converted into texts. Then, based on the texts and according to the cosine similarity between entries and the cosine similarity between entries and texts, multiple texts are combined into one text. Finally, the combined text is converted into an entry structure which is a synthetic entry.

During the conversion of the entry structures into texts, the entry attributes in the entry structure are stored in accordance with key-value pairs by hash storage. The entry attributes include entry ID, entry name, entry text, parent entry and children entry. In the process of converting the entry structures into texts, the entry attributes of root entries in the entry structure and the entry attributes of all sub-entries subordinate to the root entries are read in the format of text.

Conversely, in the process of converting texts into entry structures, the entry attributes involved in the texts are stored as entry structures in accordance with key-value pairs by hash storage. The entry attributes include entry ID, entry name, entry text, parent entry and children entry.

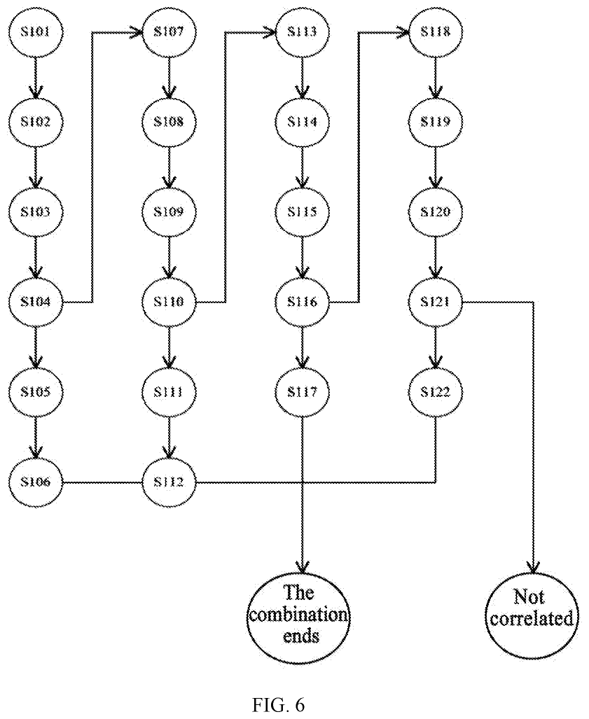

However, the process of combining texts based on the cosine similarity is realized by calculating the cosine similarity between entries and the cosine similarity between entries and texts. The following description will be given by taking the combination of two texts as an example. The specific steps are shown in FIG. 6.

S101: A first text is used as a primary combination subject and a second text as a secondary combination subject.

S102: All entries of the first text are traversed by a root entry in the second text to obtain corresponding cosine similarities.

S103: The cosine similarities obtained in the S102 are compared to obtain a value of a maximum cosine similarity.

S104: If the value of the maximum cosine similarity obtained in the S103 is greater than a first threshold (i.e., 80%), S105 is executed; or otherwise, S107 is executed.

S105: An entry corresponding to the value of the maximum cosine similarity in the primary combination subject is recorded, and a root entry in the secondary combination subject is combined into the recorded corresponding entry in the primary combination subject.

S106: A cosine similarity between any two of all sub-entries of the combined entry (e.g., a new entry 1.1.3) is calculated; if the cosine similarity is greater than the first threshold (80%), the two entries are combined (the combining rule is the same as that in the S105), and the S106 is repeated for the combined entry until the cosine similarity between any two of all sub-entries of the combined entry is less than the first threshold.

S107: The second text is used as the primary combination subject and the first text as the secondary combination subject.

S108: All entries in the second text are traversed by a root entry in the second text to obtain corresponding cosine similarities.

S109: The cosine similarities obtained in the S108 are compared to obtain a value of a maximum cosine similarity.

S110: If the value of the maximum cosine similarity obtained in the S109 is greater than the first threshold (80%), S111 is executed; or otherwise, S113 is executed.

S111: An entry corresponding to the value of the maximum cosine similarity in the primary combination subject is recorded, and a root entry in the secondary combination subject is combined into the recorded corresponding entry in the primary combination subject.

S112: A cosine similarity between any two of all sub-entries of the combined entry; if the cosine similarity is greater than the first threshold (80%), the two entries are combined (the combining rule is the same as that in the S111), and the S112 is repeated for the combined entry until the cosine similarity between any two of all sub-entries of the combined entry is less than the first threshold (80%), and the combination ends.

S113: The first text is used as the primary combination subject and the second text as the secondary combination subject, again.

S114: Texts of all entries in the first text are traversed by a root entry in the second text traverses to obtain corresponding cosine similarities.

S115: The cosine similarities obtained in the S114 are compared to obtain a value of a maximum cosine similarity.

S116: If the value of the maximum cosine similarity obtained in the S115 is greater than a second threshold (60%), S117 is executed; or otherwise, S118 is executed.

S117: An entry corresponding to the value of the maximum cosine similarity in the primary combination subject is recorded, and a root entry in the secondary combination subject is combined into the recorded corresponding entry in the primary combination subject.

S118: The second text is used as the primary combination subject and the first text as the secondary combination subject.

S119: Texts of all entries in the second text are traversed by a root entry in the first text to obtain corresponding cosine similarities.

S120: The cosine similarities obtained in the S119 are compared to obtain a value of a maximum cosine similarity.

S112: If the value of the maximum cosine similarity obtained in the S120 is greater than the second threshold (60%), S122 is executed; or otherwise, it is determined that the texts of the two entries are not correlated.

S122: An entry corresponding to the value of the maximum cosine similarity in the primary combination subject is recorded, a root entry in the secondary combination subject is combined into the recorded corresponding entry in the primary combination subject, and the combination ends.

Additionally, searching consistent or similar combined entries can also be realized by a method similar to the aforementioned automatic recommendation method based on the cosine similarity. Specifically, a structure of a root entry newly created by a user is received, and the structure is converted into a text in real time and then stored; the newly-created root entry converted into a text is compared in cosine similarity with other existing root entries converted into texts; the text of an existing root entry with a cosine similarity exceeding a preset threshold is converted into a structure, and the structure is presented to the user as a recommendation; and, the text of an existing root entry with a cosine similarity less than the preset threshold is not presented to the user. The comparison of cosine similarities between entries is similar to the comparison of cosine similarities between the combined entries described above and will not be repeated here.

S22: The synthetic entry recommendation module 1023 inserts the searched entry structure of the synthetic entry in an entry structure of the new entry.

During the insertion process, the edition unit 10221 edits the entry structure of the synthetic entry. The edition includes deletion and addition of the entry structure and adjustment of a logical relationship among entries.

### First Embodiment of the Intelligent Pushing System for Related Contents of Newly-Created Entries

FIG. 3 shows the principle of a first embodiment of the intelligent pushing system for related contents of newly-created entries according to the present invention. With reference to FIG. 3, the system in this embodiment includes a terminal device 200, the terminal device 200 including an application-specific integrated circuit; and,

a cloud server 100 coupled to the terminal device 200 via a communication medium 300, the cloud server 100 including one or more processors 101 and a non-volatile memory 102 storing instructions, wherein:

the instructions, when executed, cause the one or more processors 101 to receive instructions from the terminal device 200 via the communication medium 300, and

the non-volatile memory 102 of the cloud server includes an original entry search module 1021 and an entry insertion module 1022.

The original entry search module 1021 is configured to, during the creation of a new entry in an entry structure, search, based on the new entry to be created and on an entry structured platform, an entry structure of an original entry the same as or similar to the new entry.

The entry structured platform stores entry structures created by multiple users. For example, when a creator enters “Physics”, the platform automatically searches, from all the stored entry structures, “Nuclear physics|subordinate to a root entry READING”, “Astrophysics|subordinate to the root entry READING”, “Physics|subordinate to a root entry INTERGENERATION PROFILE”, etc.

The entry insertion module 1022 is configured to recommend, to a creator of the new entry, all searched entry structures for the creator's selection and insert the selected entry structure in the created new entry.

The entry insertion module 1022 includes an edition unit 10221 configured to edit the selected entry structure. The edition includes deletion and addition of the entry structure and adjustment of a logical relationship among entries.

### Second Embodiment of the Intelligent Pushing System for Related Contents of Newly-Created Entries

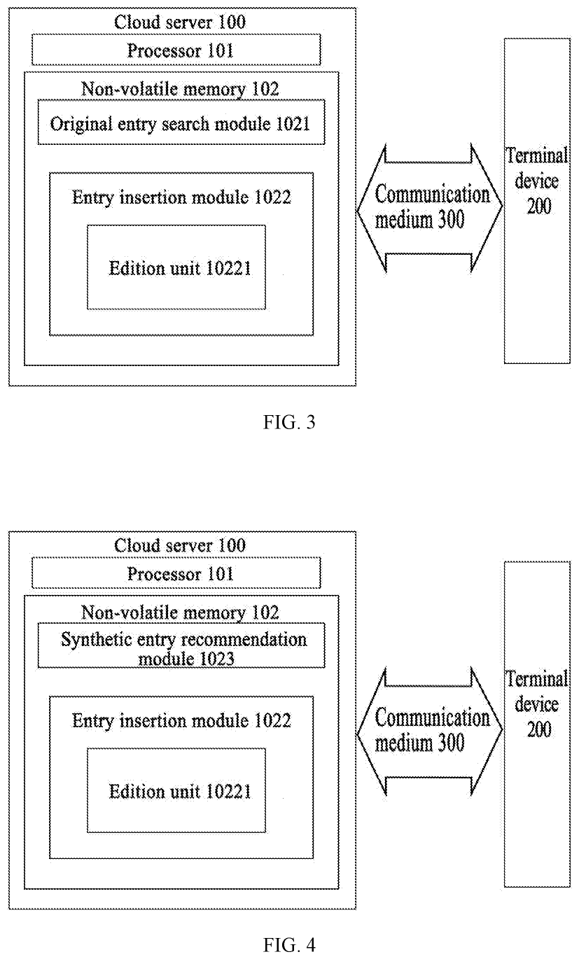

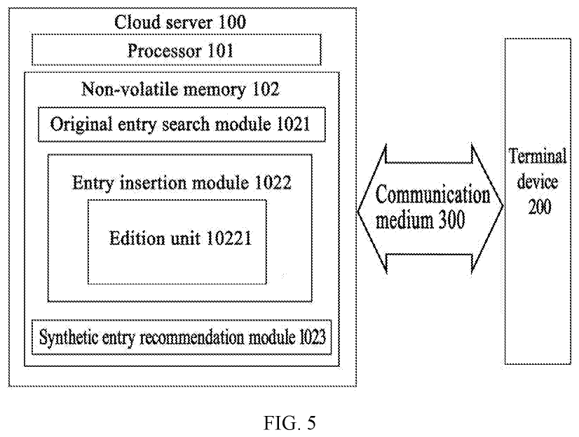

FIGS. 4 and 5 show the principle of a second embodiment of the intelligent pushing system for related contents of newly-created entries according to the present invention. With reference to FIG. 4, the system in this embodiment includes a synthetic entry recommendation module 1023 and an entry insertion module 1022. As shown in FIG. 5, in this embodiment, a synthetic entry recommendation module 1023 may also be provided based on the first embodiment of the intelligent pushing system for related contents of newly-created entries. The synthetic entry recommendation module 1023 is configured to, during the creation of a new entry in an entry structure, search, based on the new entry to be created and on an entry structured platform, an entry structure of a synthetic entry the same as or similar to the new entry.

The entry structured platform stores entry structures created by multiple users and entry structures of the synthetic entries. Multiple similar original entry structures are combined into an entry structure of a new synthetic entry.

The formation of the synthetic entry depends on the conversion from the entry structures to texts and a cosine similarity based on the texts. More specifically, the original entry structures are converted into texts. Then, based on the texts and according to the cosine similarity between entries and the cosine similarity between entries and texts, multiple texts are combined into one text. Finally, the combined text is converted into an entry structure which is a synthetic entry.

During the conversion of the entry structures into texts, the entry attributes in the entry structure are stored in accordance with key-value pairs by hash storage. The entry attributes include entry ID, entry name, entry text, parent entry and children entry. In the process of converting the entry structures into texts, the entry attributes of root entries in the entry structure and the entry attributes of all sub-entries subordinate to the root entries are read in the format of text.

Conversely, in the process of converting texts into entry structures, the entry attributes involved in the texts are stored as entry structures in accordance with key-value pairs by hash storage. The entry attributes include entry ID, entry name, entry text, parent entry and children entry.

However, the process of combining texts based on the cosine similarity is realized by calculating the cosine similarity between entries and the cosine similarity between entries and texts. The following description will be given by taking the combination of two texts as an example. The specific steps are shown in FIG. 6.

S101: A first text is used as a primary combination subject and a second text as a secondary combination subject.

S102: All entries of the first text are traversed by a root entry in the second text to obtain corresponding cosine similarities.

S103: The cosine similarities obtained in the S102 are compared to obtain a value of a maximum cosine similarity.

S104: If the value of the maximum cosine similarity obtained in the S103 is greater than a first threshold (i.e., 80%), S105 is executed; or otherwise, S107 is executed.

S105: An entry corresponding to the value of the maximum cosine similarity in the primary combination subject is recorded, and a root entry in the secondary combination subject is combined into the recorded corresponding entry in the primary combination subject.

S106: A cosine similarity between any two of all sub-entries of the combined entry (e.g., a new entry 1.1.3) is calculated; if the cosine similarity is greater than the first threshold (80%), the two entries are combined (the combining rule is the same as that in the S105), and S106 is repeated for the combined entry until the cosine similarity between any two of all sub-entries of the combined entry is less than the first threshold.

S107: The second text is used as the primary combination subject and the first text as the secondary combination subject.

S108: All entries in the second text are traversed by a root entry in the second text to obtain corresponding cosine similarities.

S109: The cosine similarities obtained in the S108 are compared to obtain a value of a maximum cosine similarity.

S110: If the value of the maximum cosine similarity obtained in the S109 is greater than a first threshold (80%), S111 is executed; or otherwise, S113 is executed.

S111: An entry corresponding to the value of the maximum cosine similarity in the primary combination subject is recorded, and a root entry in the secondary combination subject is combined into the recorded corresponding entry in the primary combination subject.

S112: A cosine similarity between any two of all sub-entries of the combined entry; if the cosine similarity is greater than the first threshold (80%), the two entries are combined (the combining rule is the same as that in S111), and the S112 is repeated for the combined entry until the cosine similarity between any two of all sub-entries of the combined entry is less than the first threshold (80%), and the combination ends.

S113: The first text is used as the primary combination subject and the second text as the secondary combination subject again.

S114: Texts of all entries in the first text are traversed by a root entry in the second text traverses to obtain corresponding cosine similarities.

S115: The cosine similarities obtained in the S114 are compared to obtain a value of a maximum cosine similarity.

S116: If the value of the maximum cosine similarity obtained in the S115 is greater than a second threshold (60%), S117 is executed; or otherwise, S118 is executed.

S117: An entry corresponding to the value of the maximum cosine similarity in the primary combination subject is recorded, and a root entry in the secondary combination subject is combined into the recorded corresponding entry in the primary combination subject.

S118: The second text is used as the primary combination subject and the first text as the secondary combination subject.

S119: Texts of all entries in the second text are traversed by a root entry in the first text to obtain corresponding cosine similarities.

S120: The cosine similarities obtained in the S119 are compared to obtain a value of a maximum cosine similarity.

S112: If the value of the maximum cosine similarity obtained in the S120 is greater than the second threshold (60%), S122 is executed; or otherwise, it is determined that the texts of the two entries are not correlated.

S122: An entry corresponding to the value of the maximum cosine similarity in the primary combination subject is recorded, a root entry in the secondary combination subject is combined into the recorded corresponding entry in the primary combination subject, and the combination ends.

Additionally, the method for searching consistent or similar combined entries can also be realized by a method similar to the aforementioned automatic recommendation method based on the cosine similarity. Specifically, a structure of a root entry newly created by a user is received, and the structure is converted into a text in real time and then stored; the newly-created root entry converted into a text is compared in cosine similarity with other existing root entries converted into texts; the text of an existing root entry with a cosine similarity exceeding a preset threshold is converted into a structure, and the structure is presented to the user as a recommendation; and, the text of an existing root entry with a cosine similarity less than the preset threshold is not presented to the user. The comparison of cosine similarities between entries is similar to the comparison of cosine similarities between the combined entries described above and will not be repeated here.

The entry insertion module 1022 is configured to insert the searched entry structure of the synthetic entry in an entry structure of the new entry.

The entry insertion module 1022 includes an edition unit 10221 configured to edit a synthetic entry structure to be inserted. The edition includes deletion and addition of the entry structure, and adjustment of a logical relationship among entries.

Although the methods described above are shown and described as a series of actions for simplicity of explanation, it should be understood and appreciated that these methods are not limited to the order of actions. In accordance with one or more embodiments, some actions may be executed in a different order and/or be executed concurrently with other actions that are shown and described herein or are not shown and described herein but can be understood by those skilled in the art.

It will be further appreciated by those skilled in the art that the communication medium 300 refers to connections, digital subscriber lines (DSLs) or wireless technologies such as infrared, radio and microwave, which allow the transmission of data structures from websites, servers or remote sources via coaxial cables, optical cables or twisted-pair wires.

It will be further appreciated by those skilled in the art that various illustrative logic blocks, modules, circuits and algorithm steps described by the embodiments disclosed herein can be implemented as electronic hardware, computer software or a combination thereof. To clearly illustrate the interchangeability of hardware and software, various illustrative components, blocks, modules, circuits and steps have been generally described above in terms of functionality. The implementation of such functionality as hardware or software depends on the specific application and the design constraints to the whole system. Technicians can implement the described functionality in different ways for each particular application, but such implementation decisions shall not be regarded as departing from the scope of the present invention.

Various illustrative logic blocks, modules and circuits described by the embodiments disclosed herein can be implemented or executed by general-purpose processors, digital signal processors (DSPs), application-specific integrated circuit (ASICs), field programmable gate arrays (FPGAs) or other programmable logic devices, discrete gate or transistor logics, discrete hardware components, or any combination thereof that is designed to execute the functions described herein. The general-purpose processor may be a microprocessor. Alternatively, the processor may be any conventional processor, controller, microcontroller or state machine. The processor may also be implemented as a combination of computing devices, for example, a combination of a DSP and a microprocessor, multiple microprocessors, one or more microprocessors collaborated with the DSP core, or any other such configuration.

The steps of the methods or algorithms described in the embodiments disclosed herein may be directly embodied in hardware, a software module executed by the processor, or a combination thereof. The software module may reside in RAMs, flash memories, ROMs, EPROMs, EEPROMs, registers, hard disks, removable disks, CD-ROMs, or any form of storage media well-known in the art. The exemplary storage media are coupled to the processor so that the processor can read information from and write information in the storage media. Alternatively, the storage media may be integrated into the processor. The processor and the storage media may reside in the ASIC. The ASIC may reside in a user terminal. Alternatively, the processor and the storage media may reside in the user terminal as discrete components.

In one or more exemplary embodiments, the described functions may be implemented in hardware, software, firmware or any combination thereof. If the functions are implemented as computer program products in software, the functions may be stored on computer readable media or transmitted via the computer readable media as one or more instructions or codes. The computer readable media include computer storage media and communication media, including any media that facilitate the transfer of computer programs from one location to another location. The storage media may be any available media accessible by a computer. As a non-limiting example, the computer readable media may include RAMs, ROMs, EEPROMs, CD-ROMs, or other optical disk storages, magnetic disk storages or other magnetic storage devices, or any other media that can be used to carry or store desired program codes in form of instructions or data structures and can be accessed by a computer. Any connections are also properly referred to as computer readable media. For example, if software is transmitted from web sites, servers or other remote sources by coaxial cables, optical fiber cables, twisted-pair wires, digital subscriber lines (DSLs) or wireless technologies such as infrared, radio and microwave, the coaxial cables, the optical fiber cables, the twisted-pair wires, the DSLs or the wireless technologies such as infrared, radio and microwave are included in the definition of media. Disks and discs as used herein include compact discs (CDs), laser discs, optical discs, digital versatile discs (DVDs), floppy disks and Blu-ray discs, wherein the disks often reproduce data magnetically, while the discs reproduce data optically by laser. The combinations of the above shall also be included in the scope of the computer readable media.

The foregoing description of the present disclosure is provided to enable any person skilled in the art to practice or utilize the present disclosure. Various modifications to the present disclosure will be apparent to those skilled in the art, and the general principles defined herein are applicable to other variations without departing from the spirit or scope of the present disclosure. Therefore, the present disclosure is not limited to the examples and designs described herein, and should be granted with the broadest scope consistent with the principles and novel features described herein.

What is claimed is:

1. An intelligent pushing method for related contents of newly-created entries, comprising steps of:
transmitting instructions to a cloud server by a terminal device via a communication medium, the cloud server comprising one or more processors and a non-volatile memory storing instructions;
during the creation of a new entry in an entry structure, by an original entry search module of the non-volatile memory, searching, based on the new entry to be created and on an entry structured platform, an entry structure of an original entry the same as or similar to the new entry, the entry structured platform storing entry structures created by multiple users; and
recommending, by an entry insertion module of the non-volatile memory and to a creator of the new entry, all searched entry structures for the creator's selection, and inserting the selected entry structure in the created new entry.

2. The intelligent pushing method for related contents of newly-created entries according to claim 1, wherein, in the process of inserting the selected entry structure in the created new entry, the selected entry structure is edited by an edition unit, the edition comprising deletion and addition of the entry structure, and adjustment of a logical relationship among entries.

3. The intelligent pushing method for related contents of newly-created entries according to claim 1, further comprising steps of:
during the creation of a new entry in an entry structure, by a synthetic entry recommendation module, searching, based on the new entry to be created and on the entry structured platform, an entry structure of a synthetic entry the same as or similar to the new entry, the entry structured platform storing entry structures created by multiple users and entry structures of the synthetic entries, multiple similar original entry structures being combined into an entry structure of a new synthetic entry; and
inserting, by the entry insertion module, the searched entry structure of the synthetic entry in an entry structure of the new entry.

4. The intelligent pushing method for related contents of newly-created entries according to claim 3, wherein, in the process of inserting the searched entry structure of the synthetic entry in the entry structure of the new entry, the entry structure of the synthetic entry is edited by the edition unit, the edition comprising deletion and addition of the entry structure, and adjustment of a logical relationship among entries.

5. The intelligent pushing method for related contents of newly-created entries according to claim 3, wherein, based on the conversion from the entry structures to texts and a cosine similarity based on the texts, multiple similar original entry structures are automatically combined into an entry structure of a new synthetic entry.

6. An intelligent pushing system for related contents of newly-created entries, comprising:
a terminal device, the terminal device comprising an application-specific integrated circuit; and
a cloud server coupled to the terminal device via a communication medium, the cloud server comprising one or more processors and a non-volatile memory storing instructions, wherein:
the instructions, when executed, cause the one or more processor to receive instructions from the terminal device via the communication medium,
the non-volatile memory of the cloud server comprises:
an original entry search module configured to, during the creation of a new entry in an entry structure, search, based on the new entry to be created and on an entry structured platform, an entry structure of an original entry the same as or similar to the new entry, the entry structured platform storing entry structures created by multiple users; and
an entry insertion module configured to recommend, to a creator of the new entry,
all searched entry structures for the creator's selection and insert the selected entry structure in the created new entry.

7. The intelligent pushing system for related contents of newly-created entries according to claim 6, wherein the entry insertion module comprises:
an edition unit configured to edit the selected entry structure, the edition comprising deletion and addition of the entry structure and adjustment of a logical relationship among entries.

8. The intelligent pushing system for related contents of newly-created entries according to claim 6, wherein the non-volatile memory of the cloud server further comprises:
a synthetic entry recommendation module configured to, during the creation of a new entry in an entry structure, search, based on the new entry to be created and on the entry structured platform, an entry structure of a synthetic entry the same as or similar to the new entry, the entry structured platform storing entry structures created by multiple users and entry structures of the synthetic entries, multiple similar original entry structures being combined into an entry structure of a new synthetic entry; and
the entry insertion module is further configured to insert the searched entry structure of the synthetic entry in an entry structure of the new entry.

9. The intelligent pushing system for related contents of newly-created entries according to claim 8, wherein:
the edition unit is further configured to edit the synthetic entry structure to be inserted, the edition comprising deletion and addition of the entry structure and adjustment of a logical relationship among entries.

10. The intelligent pushing system for related contents of newly-created entries according to claim 8, wherein, based on the conversion from the entry structures to texts and a cosine similarity based on the texts, multiple similar original entry structures are automatically combined into an entry structure of a new synthetic entry.
